(19) United States
(12) Patent Application Publication
(10) Pub. No.: US 2014/0067315 A1
(43) Pub. Date: Mar. 6, 2014

(54) METHOD AND APPARATUS FOR MULTIMODAL BIDIRECTIONAL CROWD SHAPING

(71) Applicants: Jussi Leppanen, Tampere (FI); Sujeet Shyamsundar Mate, Tampere (FI)

(72) Inventors: Jussi Leppanen, Tampere (FI); Sujeet Shyamsundar Mate, Tampere (FI)

(73) Assignee: Nokia Corporation, Espoo (FI)

(21) Appl. No.: 13/601,469

(22) Filed: Aug. 31, 2012

(51) Int. Cl. G06F 15/00

(52) U.S. Cl. 702/150

(57) ABSTRACT

A method, apparatus, computer program product and system are provided for facilitating multimodal bidirectional crowd shaping. In this regard, a method is provided that includes receiving at least two types of positional information. The method further includes determining respective weights for the at least two types of positional information and then determining an estimated number of users located at one or more positions based on the positional information and respective weights. According to a further embodiment, one or more statuses may also be determined and the weights may be determined based at least in part on the status, such that the respective weights may be adjusted in accordance with changes in the one or more statuses.

### TECHNOLOGICAL FIELD

An example embodiment of the present invention relates generally to techniques for managing crowd shapes and, more particularly, to a method and apparatus for facilitating multimodal bidirectional crowd shaping.

### BACKGROUND

Crowd shaping techniques seek to achieve a desired distribution of a crowd of people in within a certain area. Effective crowd shaping may be useful in a variety of scenarios. One example of such a scenario is the gathering of footage for a crowd sourced video of an event. In this case, if all of the footage of the event has been filmed from the same or similar locations, the final video may be bland and monotonous. To overcome this problem, individual users may be asked to move to different locations at the event to maximize the different shooting angles. However, telling each individual user to move to a particular location at an event can be cumbersome, and perhaps even annoying for the users.

### BRIEF SUMMARY

A method, apparatus and computer program product are therefore provided according to an example embodiment of the present invention for facilitating multimodal bidirectional crowd shaping. In this regard, the method, apparatus, and computer program product of one embodiment may determine an estimated number of users located at one or more positions based on various types of positional information, the positional information being weighted according to its type. In this way, the method, apparatus, and computer program may make more accurate estimations of the number of users located at the one or more positions. For example, the weights may vary according to a status, such as a temporal status or other status, permitting the estimations to be made in a status-appropriate manner.

In one embodiment, a method is provided that includes receiving or determining two or more types of positional information, determining respective weights for each of the two or more types of positional information, and determining an estimated number of users located at one or more positions based on the positional information and the respective weights. According to a further embodiment, the method may further include determining a status, wherein the respective weights are determined based at least in part on the status.

In a further embodiment, an apparatus is provided that includes at least one processor and at least one memory including program code instructions, the at least one memory and the program code instructions being configured to, with the processor, direct the apparatus to at least receive or determine two or more types of positional information, determine respective weights for each of the two or more types of positional information, and determine an estimated number of users located at one or more positions based on the positional information and the respective weights. According to a further embodiment, the apparatus may be further caused to determine a status, wherein the apparatus is caused to determine the respective weights based at least in part on the status.

In an even further embodiment, a computer program product is provided that includes a non-transitory computer readable medium storing program code portions therein. The computer program code instructions are configured to, upon execution, direct an apparatus to at least receive or determine two or more types of positional information, determine respective weights for each of the two or more types of positional information, and determine an estimated number of users located at one or more positions based on the positional information and the respective weights. According to a further embodiment, the apparatus may be further caused to determine a status, wherein the apparatus is caused to determine the respective weights based at least in part on the status.

In a still further embodiment, an apparatus is provided that includes means for receiving or determining two or more types of positional information, means for determining respective weights for each of the two or more types of positional information, and means for determining an estimated number of users located at one or more positions based on the positional information and the respective weights. According to a further embodiment, the apparatus may further include means for determining a status, wherein the means for determining the respective weights comprise means for determining the respective weights based at least in part on the status.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a schematic representation of a system that may support example embodiments of the present invention;

FIG. 2 is a block diagram of an electronic device that may be configured to implement example embodiments of the present invention;

FIG. 3 is a block diagram of an apparatus that may be embodied by or associated with an electronic device, and may be configured to implement example embodiments of the present invention;

FIG. 4 is a flowchart illustrating operations performed in accordance with example embodiments of the present invention; and

FIGS. 5a through 6b are schematic representations of user interfaces which may be caused to be displayed in accordance with example embodiments of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As described below, a method, apparatus and computer program product are provided for facilitating multimodal bidirectional crowd shaping. In this regard, the method, apparatus, and computer program product of one embodiment may allow accurate estimations to be made of the number of users located at one or more positions.

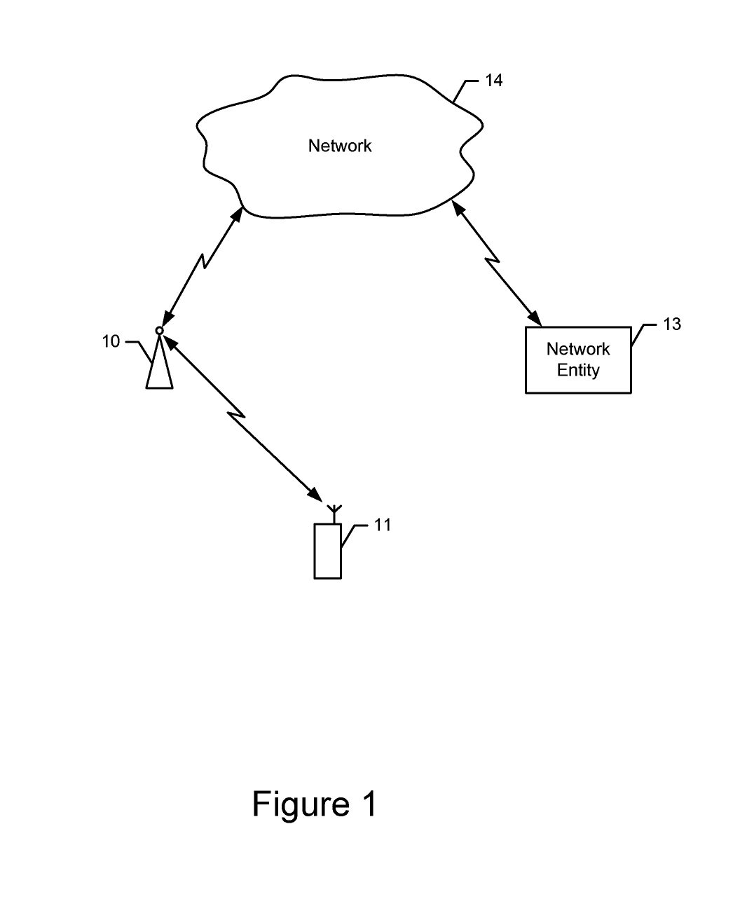

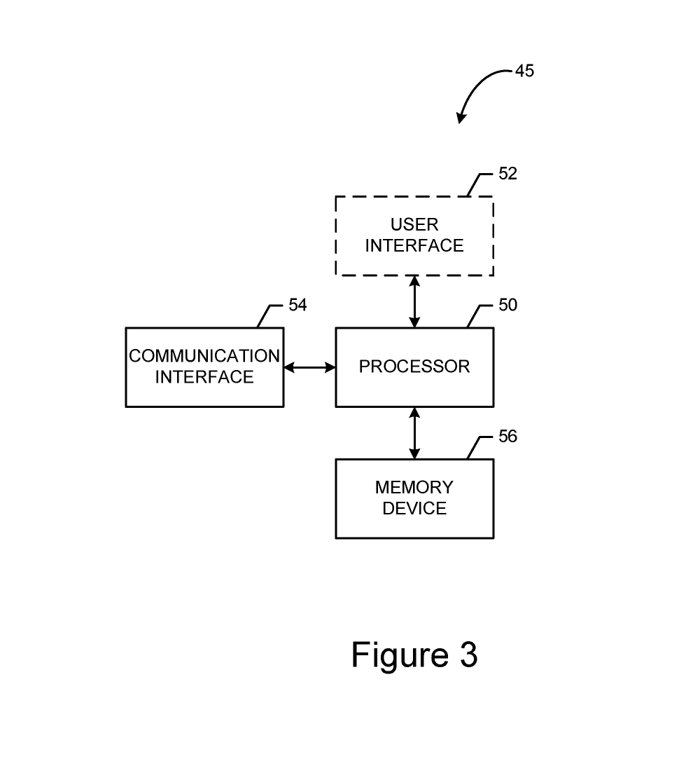

FIG. 1 illustrates a block diagram of a system that may benefit from embodiments of the present invention. While FIG. 1 illustrates one example of a system that would benefit from the present invention, numerous other systems and configurations may also benefit from embodiments of the present invention. With reference to FIG. 1, however, the system may include a user device 11, connected to a network 14 via an access point 10, and a network entity 13 also connected to network 14. User device 11 may be any device that is configured to communicate over any type of network. For example, user device 11 may be a mobile terminal, such as a mobile telephone, PDA, pager, laptop computer, tablet computer, or any of numerous other hand held or portable communication devices, computation devices, content generation devices, content consumption devices, or combinations thereof. User device 11 and network entity 13 may include or be associated with an apparatus 45, such as shown in FIG. 3, configured in accordance with embodiments of the present invention, as described below.

As shown in FIG. 1, user device 11 and network entity 13 may communicate with one another via network 14, which user device 11 may connect to via access point 10. User device 11 and access point 10 may communicate with each other via wireless means such as, for example, WI-FI, BLUETOOTH, or the like, or via wired means such as Ethernet, USB (Universal Serial Bus), or the like. Access point 10 may also allow device 11 to access network 14 via a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network. Access point 10 may communicate with network 14 via wired means, such as via fiber optic or coaxial cable, twisted-pair Ethernet cable, digital subscriber line (DSL), or by connecting with a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network. Network entity 13 may similarly communicate with network 14 via wired or wireless means. Thus, it should be understood that embodiments of the present invention may be implemented in any type of system in which a device, such as device 11, may communicate with another entity, such as network entity 13. The means by which the device and entity communicate, and any intervening entities, devices, networks, communications means, or the like, may not affect the operations of embodiments of the present invention.

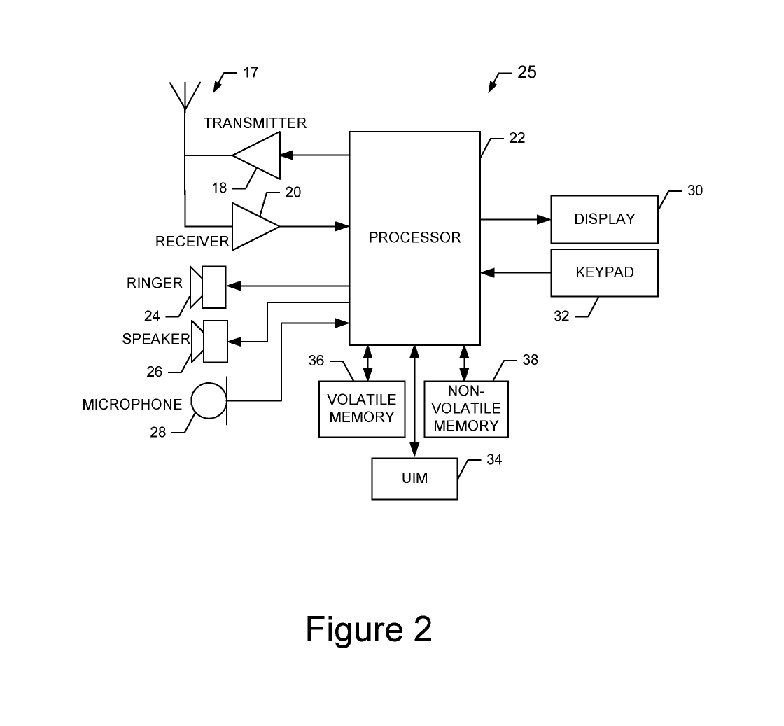

In one embodiment, user device 11 may be embodied by a mobile terminal. In this regard, a block diagram of a mobile terminal 25 that would benefit from embodiments of the present invention is illustrated in FIG. 2. It should be understood, however, that the mobile terminal 25 as illustrated and hereinafter described is merely illustrative of one type of user device that may benefit from embodiments of the present invention and, therefore, should not be taken to limit the scope of embodiments of the present invention. As such, although numerous types of mobile terminals, such as PDAs, mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, may readily employ embodiments of the present invention, other user devices including fixed (non-mobile) electronic devices may also employ some example embodiments.

The mobile terminal 25 may include an antenna 17 (or multiple antennas) in operable communication with a transmitter 18 and a receiver 20. The mobile terminal 25 may further include an apparatus, such as a processor 22 or other processing device (e.g., processor 50 of the apparatus of FIG. 3), which controls the provision of signals to, and the receipt of signals from, the transmitter 18 and receiver 20, respectively. The signals may include signaling information in accordance with the air interface standard of an applicable cellular system, and also user speech, received data and/or user generated data. In this regard, the mobile terminal 25 is capable of operating with one or more air interface standards, communication protocols, modulation types, and access types. By way of illustration, the mobile terminal 25 is capable of operating in accordance with wireless communication mechanisms. For example, mobile terminal 25 may be capable of communicating in a wireless local area network (WLAN) or other communication networks, for example in accordance with one or more of the IEEE 802.11 family of standards, such as 802.11a, b, g, or n. As an alternative (or additionally), the mobile terminal 25 may be capable of operating in accordance with any of a number of first, second, third and/or fourth-generation cellular communication protocols or the like. For example, the mobile terminal 25 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like.

In some embodiments, the processor 22 may include circuitry desirable for implementing audio and logic functions of the mobile terminal 25. For example, the processor 22 may be comprised of a digital signal processor device, a microprocessor device, and various analog to digital converters, digital to analog converters, and other support circuits. Control and signal processing functions of the mobile terminal 25 are allocated between these devices according to their respective capabilities. The processor 22 thus may also include the functionality to convolutionally encode and interleave message and data prior to modulation and transmission. The processor 22 may additionally include an internal voice coder, and may include an internal data modem. Further, the processor 22 may include functionality to operate one or more software programs, which may be stored in memory. For example, the processor 22 may be capable of operating a connectivity program, such as a conventional Web browser. The connectivity program may then allow the mobile terminal 25 to transmit and receive Web content, such as location-based content and/or other web page content, according to a Wireless Application Protocol (WAP), Hypertext Transfer Protocol (HTTP) and/or the like, for example.

The mobile terminal 25 may also comprise a user interface including an output device such as a conventional earphone or speaker 26, a ringer 24, a microphone 28, a display 30, and a user input interface, all of which are coupled to the processor 22. The user input interface, which allows the mobile terminal 25 to receive data, may include any of a number of devices allowing the mobile terminal 25 to receive data, such as a keypad 32, a touch screen display (display 30 providing an example of such a touch screen display) or other input device. In embodiments including the keypad 32, the keypad 32 may include the conventional numeric (0-9) and related keys (#, *), and other hard and soft keys used for operating the mobile terminal 25. Alternatively or additionally, the keypad 32 may include a conventional QWERTY keypad arrangement. The keypad 32 may also include various soft keys with associated functions. In addition, or alternatively, the mobile terminal 25 may include an interface device such as a joystick or other user input interface. Some embodiments employing a touch screen display, as described further below, may omit the keypad 32 and any or all of the speaker 26, ringer 24, and microphone 28 entirely. The mobile terminal 25 further includes a battery, such as a vibrating battery pack, for powering various circuits that are required to operate the mobile terminal 25, as well as optionally providing mechanical vibration as a detectable output.

The mobile terminal 25 may further include a user identity module (UIM) 34. The UIM 34 is typically a memory device having a processor built in. The UIM 34 may include, for example, a subscriber identity module (SIM), a universal integrated circuit card (UICC), a universal subscriber identity module (USIM), a removable user identity module (R-UIM), etc. The UIM 34 typically stores information elements related to a mobile subscriber. In addition to the UIM 34, the mobile terminal 25 may be equipped with memory. For example, the mobile terminal 25 may include volatile memory 36, such as volatile Random Access Memory (RAM) including a cache area for the temporary storage of data. The mobile terminal 15 may also include other non-volatile memory 38, which may be embedded and/or may be removable. The memories may store any of a number of pieces of information, and data, used by the mobile terminal 15 to implement the functions of the mobile terminal 25.

Example embodiments of the invention will now be described with reference to FIG. 3, in which certain elements of an apparatus 45 for facilitating multimodal bidirectional crowd shaping. The apparatus 45 of FIG. 3 may be employed, for example, in conjunction with one or both of network entity 13 and user device 11. However, it should be noted that the apparatus 45 of FIG. 3 may also be employed in connection with a variety of other devices, both mobile and fixed, in order to facilitate multimodal bidirectional crowd shaping. For example, the apparatus 45 may be embodied by or associated with a personal computer or other user terminal.

It should also be noted that while FIG. 3 illustrates one example of a configuration of an apparatus 45 for facilitating multimodal bidirectional crowd shaping, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 3, the apparatus 45 for facilitating multimodal bidirectional crowd shaping may include or otherwise be in communication with a processor 50, a communication interface 54, and a memory device 56. As described below and as indicated by the dashed lines in FIG. 3, the apparatus 45 may also optionally include a user interface 52 in some embodiments, such as embodiments in which the apparatus 45 is embodied as user device 11. In some embodiments, the processor 50 (and/or co-processors or any other processing circuitry assisting or otherwise associated with the processor 50) may be in communication with the memory device 56 via a bus for passing information among components of the apparatus 45. The memory device 56 may include, for example, one or more volatile and/or non-volatile memories. In other words, for example, the memory device 56 may be an electronic storage device (e.g., a computer readable storage medium) comprising gates configured to store data (e.g., bits) that may be retrievable by a machine (e.g., a computing device like the processor 50). In the embodiment in which the apparatus 45 is embodied as a mobile terminal 25, the memory device 56 may be embodied by the memory 36, 38. The memory device 56 may be configured to store information, data, content, applications, instructions, or the like, for enabling the apparatus to carry out various functions in accordance with an example embodiment of the present invention. For example, the memory device 56 could be configured to buffer input data for processing by the processor 50. Additionally or alternatively, the memory device 56 could be configured to store instructions for execution by the processor 50.

The apparatus 45 may, in some embodiments, be embodied by or associated with a user terminal (e.g., mobile terminal 25) or a fixed communication device or computing device (e.g., network entity 13) configured to employ an example embodiment of the present invention. However, in some embodiments, the apparatus 45 may be embodied as a chip or chip set. In other words, the apparatus 45 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 45 may therefore, in some cases, be configured to implement an embodiment of the present invention on a single chip or as a single “system on a chip.” As such, in some cases, a chip or chipset may constitute means for performing one or more operations for providing the functionalities described herein.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include one or more processors configured in tandem via the bus to enable independent execution of instructions, pipelining and/or multithreading. In the embodiment in which the apparatus 45 is embodied as a mobile terminal 25, the processor 50 may be embodied by the processor 22.

In an example embodiment, the processor 50 may be configured to execute instructions stored in the memory device 56 or otherwise accessible to the processor 50. Alternatively or additionally, the processor 50 may be configured to execute hard coded functionality. As such, whether configured by hardware or software methods, or by a combination thereof, the processor 50 may represent an entity (e.g., physically embodied in circuitry) capable of performing operations according to an embodiment of the present invention while configured accordingly. Thus, for example, when the processor 50 is embodied as an ASIC, FPGA or the like, the processor 50 may be specifically configured hardware for conducting the operations described herein. Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (e.g., a mobile terminal or network entity) configured to employ an embodiment of the present invention by further configuration of the processor 50 by instructions for performing the algorithms and/or operations described herein. The processor 50 may include, among other things, a clock, an arithmetic logic unit (ALU) and logic gates configured to support operation of the processor 50.

Meanwhile, the communication interface 54 may be any means such as a device or circuitry embodied in either hardware or a combination of hardware and software that is configured to receive and/or transmit data from/to a network, such as network 14, and/or any other device or module in communication with the apparatus 45. In this regard, the communication interface 54 may include, for example, an antenna (or multiple antennas) and supporting hardware and/or software for enabling communications with a wireless communication network. Additionally or alternatively, the communication interface 54 may include the circuitry for interacting with the antenna(s) to cause transmission of signals via the antenna(s) or to handle receipt of signals received via the antenna(s). In some environments, the communication interface 54 may alternatively or also support wired communication. As such, for example, the communication interface 54 may include a communication modem and/or other hardware/software for supporting communication via cable, digital subscriber line (DSL), universal serial bus (USB) or other mechanisms. In the embodiment in which the apparatus 45 is embodied as a mobile terminal 15, the communication interface 54 may be embodied by the antenna 16, transmitter 18, receiver 20 or the like.

In some embodiments, such as instances in which the apparatus 45 is embodied by the user device 11, the apparatus 45 may include a user interface 52 that may, in turn, be in communication with the processor 50 to receive an indication of a user input and/or to cause provision of an audible, visual, mechanical or other output to the user. As such, the user interface 52 may include, for example, a keyboard, a mouse, a joystick, a display, a touch screen(s), touch areas, soft keys, a microphone, a speaker, or other input/output mechanisms. Alternatively or additionally, the processor 50 may comprise user interface circuitry configured to control at least some functions of one or more user interface elements such as, for example, a speaker, ringer, microphone, display, and/or the like. The processor 50 and/or user interface circuitry comprising the processor 50 may be configured to control one or more functions of one or more user interface elements through computer program instructions (e.g., software and/or firmware) stored on a memory accessible to the processor 50 (e.g., memory device 56, and/or the like). In other embodiments, however, such as in instances in which the apparatus 45 is embodied by network entity 13, the apparatus 45 may not include a user interface 52. In still other embodiments, a plurality of apparatuses 45 may be associated with respective devices or the components of the apparatus 45 may be distributed over multiple devices.

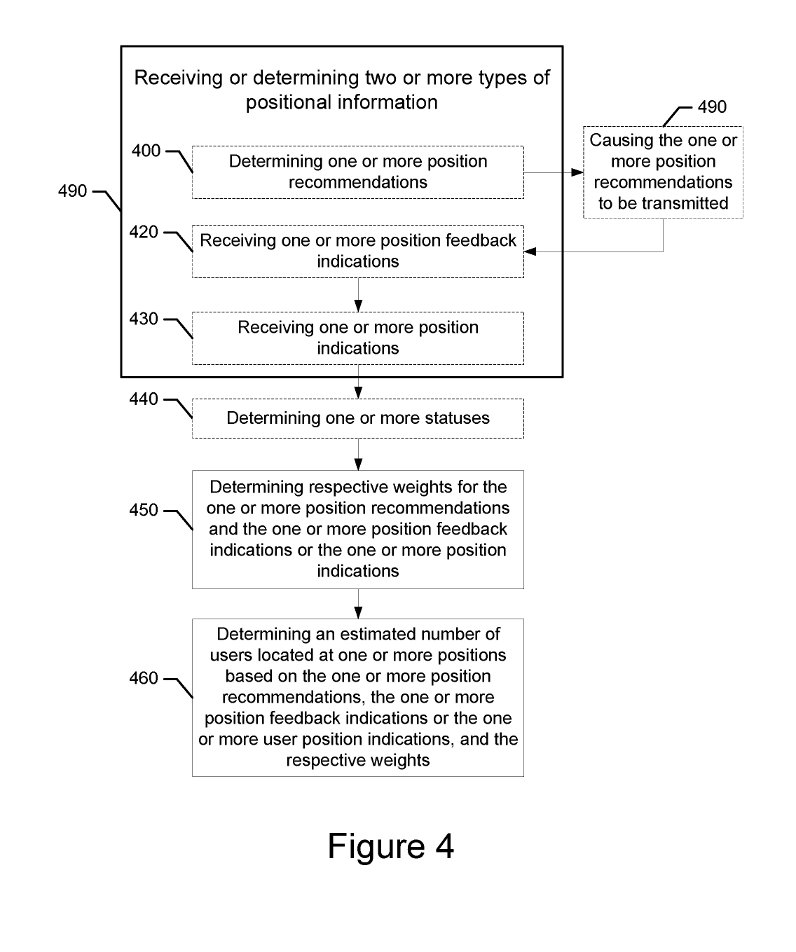

Thus, turning now to FIG. 4, the operations of the apparatus 45 for facilitating multimodal bidirectional crowd shaping will now be described. In this regard and as described below, the operations of FIG. 4 may be performed by an apparatus 45, such as shown in FIG. 3, embodied by or otherwise associated with network entity 13. In this regard, the apparatus 45 may include means, such as a processor 50, a memory device 56, and a communication interface 54 or the like, for determining and/or receiving at least two types of positional information. See operation 490. Various “types” of positional information may, for example, be distinguished based on what the positional information indicates, e.g., a recommended position, a user-estimated position, an instrument-measured position, etc. Three example positional information types will now be discussed with continuing reference to FIG. 4.

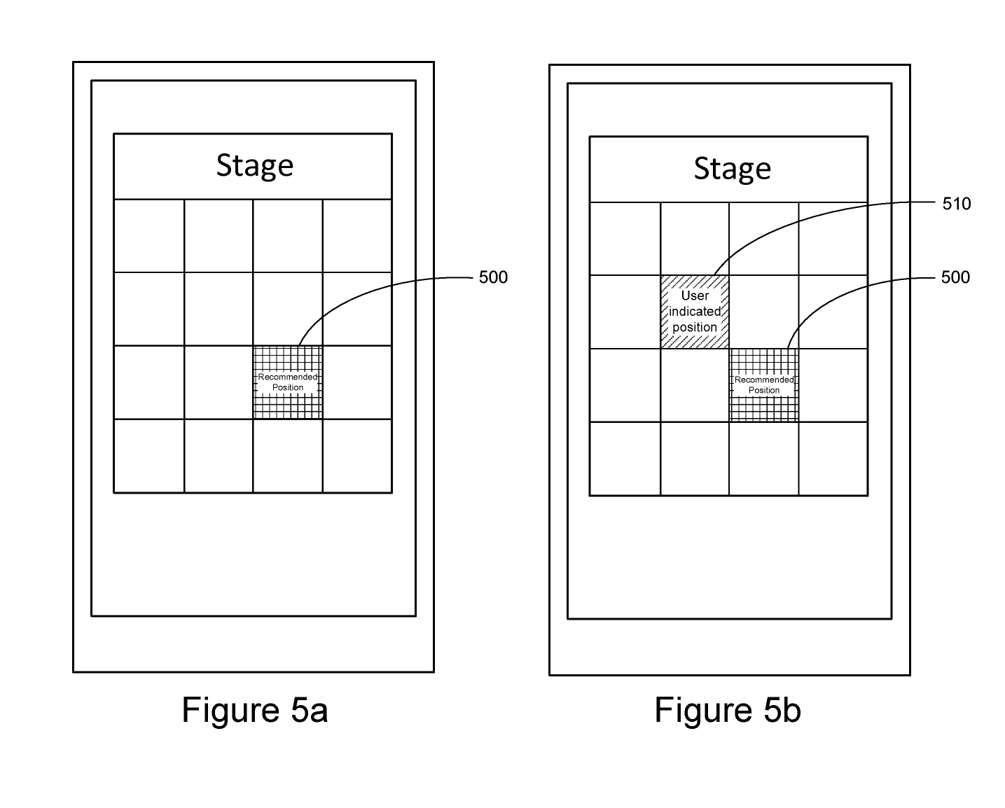

In this regard, the apparatus 45 may include means, such as a processor 50, a memory device 56, and a communication interface 54 or the like, for determining one or more position recommendations. See operation 400. The position recommendations may be determined, for example, based on an ideal or optimal crowd distribution. For example, the position recommendations may, for example, seek to achieve an even crowd distribution over an area, or a distribution in which one or more users are located at particular angles and/or distances from a particular location, such as the location of a stage or other focal point. The apparatus 45 may further include means, such as those just mentioned, for causing the one or more position recommendations to be transmitted. See operation 410. The position recommendations may, for example, be transmitted to one or more user devices, such as the user device 11 depicted in FIG. 1. For example, one position recommendation may be transmitted to each user device, such that each user receives a suggestion as to where that user should position themselves. These position recommendations may, for example, be displayed via a user interface of the user device 11, such as the user interface 52 of an apparatus 45 embodied by or otherwise associated with the user device 11, such as the display 30 of mobile terminal 25. FIGS. 5a and 5b, depict examples of such user interfaces presenting a recommended position 500.

The apparatus 45 may also include means, such as a processor 50, a memory device 56, and a communication interface 54 or the like, for receiving one or more position feedback indications. See operation 420. These position feedback indications may represent, for example, an indication received from a user, such as via a user device 11, which indicates that user's position. FIGS. 5a and 5b, depict examples of user interface which may, for example, allow the user to provide such position feedback indications. Thus, a user may be presented with recommended position 500 and then indicate, such as by selecting a position via a touchscreen or other suitable means, their actual location 510. The actual location 510 may then be caused to be transmitted, such as to the server 13, as a position feedback indication. Thus, according to an example embodiment, a user may receive a position recommendation and then indicate where they have actually positioned themselves, whether it is at the recommended location or some other location.

The apparatus 45 may further include means, such as a processor 50, a memory device 56, and a communication interface 54 or the like, for receiving one or more position indications. See operation 430 of FIG. 4. The one or more position indications may comprise position indications, such as coordinates or the like, determined by any suitable positioning device, system, or combinations of devices and/or systems. For example, the one or more positions may be determined by a GPS device or system. According to another example, the one or more positions may be determined via triangulating a WiFi, cellular, or other wireless signal. According to yet another example, the one or more positions may be determined via an audio based positioning system. According to yet another example, other suitable positioning techniques like high-accuracy indoor position or any suitable technique may be used. Each individual position indication may be determined by one or more positioning devices, systems, or combinations of devices and/or systems, and the one or more positioning devices, systems, or combinations of devices and/or systems used to determine any single position indication need not be used to determine each other position indication. Also, the positioning technique that determines relative positions for a given area or event venue is also sufficient for the purpose of the invention.

It should be understood that, as the dotted lines around operations 400, 420 and 430 of FIG. 4 show, it is not necessary that each of these three types of positional information be received. Indeed, it may be optional for a user to provide position feedback and thus, in some instances, position feedback indications may not be received from any or all users. Similarly, one or more position indications may not be capable of being determined, and therefor received, such as in an instance in which a user has deactivated certain functionality of their device (e.g., deactivating GPS or wireless functionality of their device) or in an instance in which a GPS device cannot establish a connection with enough satellites. Moreover, according to other example embodiments, other types of positional information may additionally or alternatively be received, such as information pertaining to an aggregate crowd level and/or distribution or other information.

Having received and/or determined the positional information, apparatus 45 may now determine an estimated number of users located at one or more positions. In this regard, embodiments of the present invention may determine the estimated number of users located at one or more positions based on a weighted average of the various types of positional information. For example, apparatus 45 may determine an estimated number of users located at one or more positions based on a weighted average of the position recommendations, position feedback indications and/or position indications. Thus, apparatus 45 may include means, such as a processor 50, and a memory device 56 or the like, for determining respective weights for the various types of positional information, such as for the one or more position recommendations, the one or more position feedback indications, and/or the one or more position indications. See operation 450. The weights may, for example, be determined based at least in part on a status. Thus, apparatus 45 may also include means, such as a processor 50, a memory device 56, and a communication interface or the like, for determining one or more statuses. See operation 440. The one or more determined statuses may, for example, include a temporal status. Thus, returning to the example of a crowd sourced video of an event, the temporal status may be an indication of how far along the event is, such as a length of time since the event began or the percentage of the event which has been completed or remains. The one or more statuses may also include, for example, an available positioning accuracy. Thus, according to an example embodiment, when accurate position indications are available, such as, for example, if an accurate GPS location can be established, the position indication weight may be increased. In instances in which the position indication is less accurate, such as when a GPS location cannot be established due to a lack of a satellite connection or other reason, the position indication weight may be decreased. The available positioning accuracy may be signaled, for example, by the user device, such that apparatus 45 embodied by or otherwise associated with the server 13 may receive an indication of an available positioning accuracy from the user device 11.

Various rules or formulas may be used to determine the respective weights based on the one or more determined statuses. The rules and/or formulas may, for example, be based on principals and/or models of crowd behavior. For example, and again returning to the example of a crowd sourced video of an event, there may be plenty of space at an event that has recently started and people are just beginning to arrive, which may make it easier for users to locate themselves in one or more desired locations. As the event progresses, however, and becomes more crowded, it may be more difficult to relocate. Thus, according to an example embodiment, the position recommendation may begin weighted relatively heavily and then decrease with time, e.g., it may be inversely proportional to a temporal progress status of the event. According to an example embodiment, the weights of the various types of positional information, e.g., the position recommendation weight, position feedback weight, and position indication weights, may add up to 1, such that manipulating one or more weight(s) may automatically cause the other weight(s) to also be manipulated accordingly. Thus, using the above example, as the position recommendation weight decreases with time, one or both of the position feedback and/or position indication weights may increase.

According to yet another example embodiment, the weights may be determined at least in part based on a “temporal status variation template” which, for example, takes into account temporal and/or spatial information about a given event. The temporal status variation template may, for example, incorporate information regarding the venue, such as seating arrangements and/or capacity, the locations of exits, stages, concession stands, etc.; information regarding the event itself, such as the type of event, the event schedule and/or program; and/or other types of information. Take, for example, a large event having multiple stages in which the crowd will be directed from one stage to another. In this case, the temporal status variation template may include information indicating when a first band is scheduled to complete its performance on one stage, and when another is about to start playing at another stage. Thus, when the weights are determined based on the temporal status variation template, the weights may, for example, be reset to an initial default state when the first band finishes.

Having determined the respective weights for the various types of positional information, e.g., for the position recommendations, position feedback indication, and position indications, apparatus 45 may now determine an estimated number of users located at one or more positions. See operation 460. In this regard, apparatus 45 may include means, such as a processor 50, and a memory device 56 or the like, for determining an estimated number of users located at one or more positions based on the positional information and respective weights. Thus, for example, for a given position, e.g., for a given grid cell “i,” the apparatus 45 may determine six numbers: how many position recommendations were determined and provided for the location, e.g., how many times the given position was recommended to a user (“Rᵢ”); how many position feedback indications were received for the position, e.g., how many users indicated that they were located at the given position (“Uᵢ”); how many position indications were received for the given position, e.g., how many user's devices have provided an indication that the user is located at the given position (“Pᵢ”); the recommended position weight (“wᵣ”); the position feedback weight (“wᵤ,”); and the position indication weight (“wₚ”). According to an example embodiment, the apparatus 45 may then determine the estimated number of people located at the given position, e.g., within grid cell “i” (“Nᵢ”), using the following equation: Nᵢ=wₚPᵢ+wᵤUᵢ+wᵣRᵢ. This process may then be repeated for additional positions. According to other embodiments, such as embodiments in which additional information is received and/or determined, such as information pertaining to an aggregate crowd level and/or distribution or other information, the additional information may be added to and/or replace the variables in the above calculation.

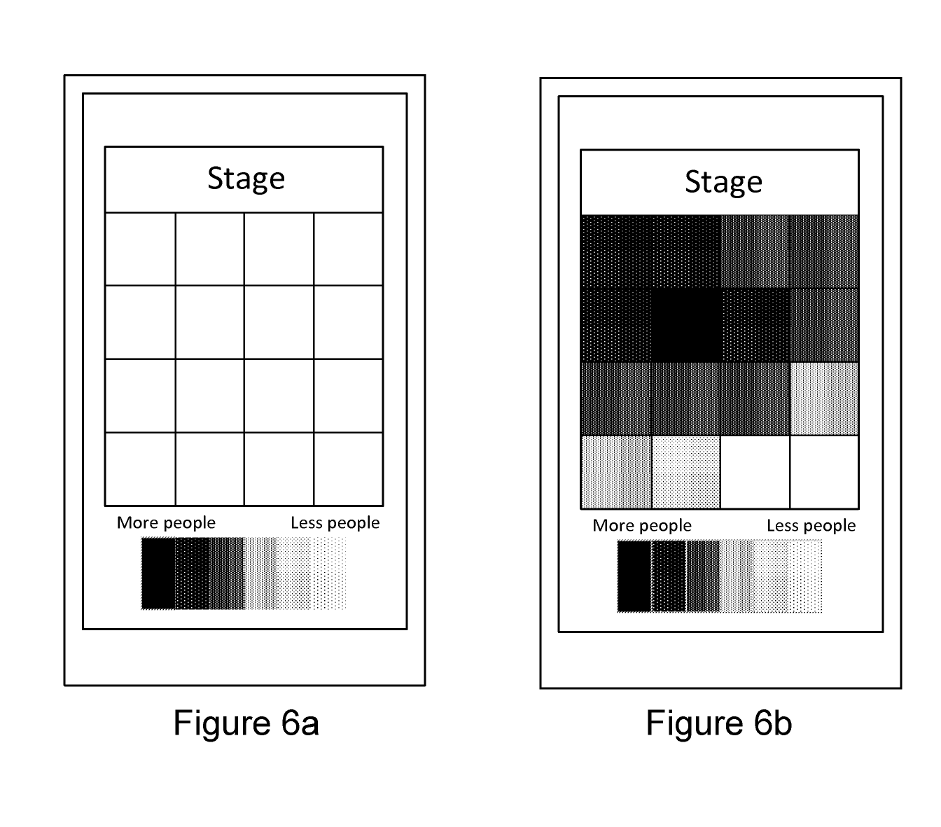

Once apparatus 45 has determined estimated numbers of users located at one or more positions, this information may be used in various ways. For example, the information may be presented or otherwise communicated to one or more users, such as users located in a crowd, e.g., to shape the crowd. For example, according to one embodiment, the information may be used to construct a visual representation of the distribution of a crowd, such as a heat map. According to an example embodiment, the visual representation may contain contextual indicators, such as a prominent object, to help orient the user. For example, if an embodiment of the present invention were being used at a concert, the stage may be included in the visual representation, to allow users to more easily orient themselves with respect to the representation. FIGS. 6a and 6b depict example user interfaces including heat map depictions of a crowd at an event, such as a concert. FIG. 6a depicts a heat map representation of the crowd before the concert starts, and 6b depicts a heat map representation of the crowd at a later time.

As described above, FIG. 4 illustrates a flowchart of an apparatus 45, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

The method, apparatus 45 and computer program product described above provide many advantages. For example the method, apparatus 45 and computer program products may facilitate crowd shaping without the hassle and inefficiency of telling each individual in a crowd where to go. In addition, embodiments of the present invention may provide more robust estimations of the number of users at given positions, and thus of overall crowd distribution, by using multiple modalities, e.g., by taking a status into account when calculating the estimations. In this way, the calculation method, e.g., the weights of different positional inputs, may be adjusted based on the circumstances.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A method comprising:
receiving or determining two or more types of positional information;
determining respective weights for each of the two or more types of positional information; and
determining an estimated number of users located at one or more positions based on the positional information and the respective weights.

2. The method of claim 1, wherein receiving or determining the two or more types of positional information comprises:
determining one or more position recommendations;
receiving one or more position feedback indications; and
receiving or one or more position indications.

3. The method of claim 1, further comprising determining a heat map representation of an area based on the estimated number of users located at the one or more positions.

4. The method of claim 1, further comprising causing the one or more position recommendations to be transmitted to one or more user devices.

5. The method of claim 1, further comprising determining a status, wherein determining the respective weights comprises determining the respective weights based at least in part on the status.

6. The method of claim 5, wherein the status comprises a temporal status.

7. The method of any of claim 6, wherein the temporal status comprises a temporal progress of an event.

8. An apparatus comprising at least one processor and at least one memory storing program code instructions, the memory and program code instructions being configured to, with the processor, direct the apparatus to at least:
receive or determine two or more types of positional information;
determine respective weights for each of the two or more types of positional information; and
determine an estimated number of users located at one or more positions based on the positional information and the respective weights.

9. The apparatus of claim 8, wherein the apparatus is caused to receive or determine the two or more types of positional information by:
determining one or more position recommendations;
receiving one or more position feedback indications; and
receiving or one or more position indications

10. The apparatus of claim 8, wherein the apparatus is further directed to determine a heat map representation of an area based on the estimated number of users located at the one or more positions.

11. The apparatus of claim 8, wherein the apparatus is further directed to cause the one or more position recommendations to be transmitted to one or more user devices.

12. The apparatus of claim 8, wherein the apparatus is further directed to determine a status, wherein determining the respective weights comprises determining the respective weights based at least in part on the status.

13. The apparatus of claim 12, wherein the status comprises a temporal status.

14. The apparatus of claim 13, the temporal status comprises a temporal progress of an event.

15. A computer program product comprising a computer readable non-transitory storage medium storing program code portions therein, the program code portions being configured to, upon execution, direct an apparatus to at least:
receive or determine two or more types of positional information;
determine respective weights for each of the two or more types of positional information; and
determine an estimated number of users located at one or more positions based on the positional information and the respective weights.

16. The computer program product of claim 15, wherein the apparatus is caused to receive or determine the two or more types of positional information by:
determining one or more position recommendations;
receiving one or more position feedback indications; and
receiving or one or more position indications

17. The computer program product of claim 15, wherein the apparatus is further directed to determine a heat map representation of an area based on the estimated number of users located at the one or more positions.

18. The computer program product of claim 15, wherein the apparatus is further directed to cause the one or more position recommendations to be transmitted to one or more user devices.

19. The computer program product of claim 15, wherein the apparatus is further directed to determine a status, wherein determining the respective weights comprises determining the respective weights based at least in part on the status.

20. The computer program product of claim 19, wherein the status comprises a temporal status.
